(19) United States
(12) Patent Application Publication
(10) Pub. No.: US 2002/0111193 A1
(43) Pub. Date: Aug. 15, 2002

(54) Transmission of digital data over a wireless network utilizing synthetic voice generation of DTMF tones

(75) Inventor: Robert K. Tendler, Chestnut Gukk, MA (US)

Correspondence Address: Robert K. Tendler, 65 Atlantic Avenue, Boston, MA, 02110, US

(73) Assignee: TENDLER CELLULAR, Inc.

(21) Appl. No.: 09/780,866

(22) Filed: Feb. 9, 2001

(51) Int. Cl. H04M 1/00

(52) U.S. Cl. 455/563; 455/404; 455/456

(57) ABSTRACT

In a wireless transceiver in which digital data is to be transmitted over a wireless network, digital data such as from a GPS receiver is encoded by a synthetic speech synthesizer, which generates DTMF tones that are injected into the audio channel. For digital wireless phones in which audio signals are digitized via compression and expansion, the utilization of the speech synthesizer provides tones of such clarity and purity that they are unaffected during the compression and expansion process.

### FIELD OF INVENTION

This invention relates to the transmission of data and more particularly to the robust transmission of digital information over a wireless network.

### BACKGROUND OF THE INVENTION

As illustrated in U.S. Pat. Nos. 4,833,477; 5,555,286; 5,598,460; 5,649,059; 5,736,962; and 6,014,555 issued to Robert K. Tendler and incorporated herein by reference, wireless handsets have been provided with GPS receivers for the determination of the position of the wireless transceiver and for transmitting this location to a remote site where the location is decoded and displayed on a map. In one instance the purpose of so doing is to provide for a robust emergency signaling system in which the location of the individual sending the distress signal can be unambiguously and accurately determined.

Many prior systems have been devised to send digital data over a wireless network indicating location as well as providing synthetic speech to indicate location over a wireless network.

One of the problems however with the introduction of digital phones having an air interface of CDMA, TDMA, GSM or iDEN, is the fact that normally generated dual tone multiple frequency, DTMF, tones are so distorted by the digital encoding of the audio that they are not robust either in the transmission or receipt. The result is that for some wireless phones the DTMF tones are generated at the cell site or in the network as opposed to being generated at the handset itself.

While it was thought that generating the DTMF tones within the network would solve the problem of the lack of robustness of transmission, in point of fact, it has introduced more problems than the originally proposed system of transmitting DTMF tones generated by the handset.

It is noted that for instance oftentimes it is impossible to use the keypad on a wireless phone to key into a telephone answering machine or other type of device connected to the audio channel of the network, much less providing a reliable means of the transmission of DTMF tones for emergency purposes.

In an effort to be able to transmit location data, in the past, modems have been utilized in an effort to rapidly communicate the necessary information. However, due to multipath and fading problems no matter how many times the data is over-sampled, information is lost when for instance the handset is in a location, albeit short, where signal fading and cancellation results in the loss of the data. While modems have been utilised in the 9600 baud range, in order to make the modem system operate in a robust manner in a wireless environment, these modems had to be slowed down to 1200 baud. Moreover, even at 1200 baud, critical information was lost and not recoverable, especially in a mobile environment.

In order to solve the problem of communicating digital data over a wireless network packet data systems have been devised which are relatively robust. Packet data systems include the so-called small message systems associated with GSM. A problem associated with such packet data or SMS systems is network occupation. What this means is that the packets of data may be delayed due to overutilisation of the network or the inability to transmit the packet due to prior packets waiting to be transmitted. In some instances, the delay in transmission of the packet data can be on the order of minutes, sometimes six minutes. This is most often seen in paging systems in which packet data is utilized to transmit the digital information to the pager.

As mentioned hereinabove, DTMF systems have been utilised for data transmission using analog phones. In analog transmission there is no digitization of the audio information in the voice channel and as a result, DTMF tones work quite well in such environments. While the transmission rate is exceedingly slow, it is exceedingly robust due to the dual tone nature of the DTMF signals. While it was thought that one could adopt DTMF for use in digital phones, the digital encryption and decryption of the audio information prevents a robust system.

### SUMMARY OF THE INVENTION

In the subject system the digital information, whether it is from a GPS receiver or any digital source is transmitted via DTMF tones over a digital wireless network in which a speech synthesizer is utilized in the generation of the DTMF tones. The output of the speech synthesizer is directly coupled to the mike input of the wireless transceiver such that the DTMF encoded signals are robustly received at a remote location regardless of the fact of the digital modulation scheme employed.

The reason is that speech synthesizers by their very nature produce absolutely the most pure form of DTMP tone available. If the speech synthesizer is made to mimic an absolutely pure waveform it will do so faithfully. Thus while in the past DTMF tones have been separately generated with different oscillators, in the subject system the tones themselves are the result of a speech generation process, which ultimately assures the quality of the tones injected into the speech channel. While the subject system will be described in connection with a speech synthesizer the subject invention also includes using a microprocessor to generate the tones which is in essence a speech synthesizer.

The result is that while in the past DTMF tones have been utilised in analog systems, the robustness of such transmission is now applicable to digital modulation schemes and other wireless air interfaces so that information may be reliably transmitted from the wireless handset to the recipient.

Nowhere is this more critical than in the area of emergency signaling such as when the location is given for an emergency call such as an E911 call. The signal strength and multipath, which exists around the particular wireless transmitter may degrade to a certain extent other methods of transmitting the location information. However, regardless of multipath and weak signal strength, DTMF tones generated in the manner described have shown to be robust in their transmission and receipt.

Moreover, this has been confirmed through the utilization of error bits, which indicate when DTMF tones have not been properly received, assuming a known sequence. The percentage of the time that no decoded DTMF is available is found to be less than one percent of the time, in the wireless transceiver indicating that regardless of the digital modulation scheme utilized, the utilization of a speech synthesizer indeed solves some of the problems associated with the transmission of DTMF tones in the prior art.

In summary, in a wireless transceiver in which digital data is to be transmitted over a wireless network, digital data such as from a GPS receiver is encoded by a synthetic speech synthesizer which generates DTMF tones that are injected into the audio channel. For digital wireless phones in which audio signals are digitized via compression and expansion, the utilization of the speech synthesizer provides tones of such clarity and purity that they are unaffected during the compression and expansion process.

### BRIEF DESCRIPTION OF THE DRAWINGS

These and other features of the subject invention will be better understood taken into account the Detailed Description in conjunction with the Drawings of which:

FIG. 1 is a block diagram of the subject system illustrating DTMF tone generation in a digital wireless transceiver network in which the location sought to be transmitted by an onboard GPS receiver is received in a remote location and indicated on an electronic chart or map; and

FIG. 2 is a block diagram illustrating the utilization of the subject speech synthesizer for the generation of DTMF tones followed by compression associated with digitizing the audio source, switching associated with the wireless network, expansion through a remote location and DTMF decoding, with all the intermediate elements providing distortion of the original signal on the audio channel, which distortion does not affect the robust receipt of the DTMF tones.

### DETAILED DESCRIPTION

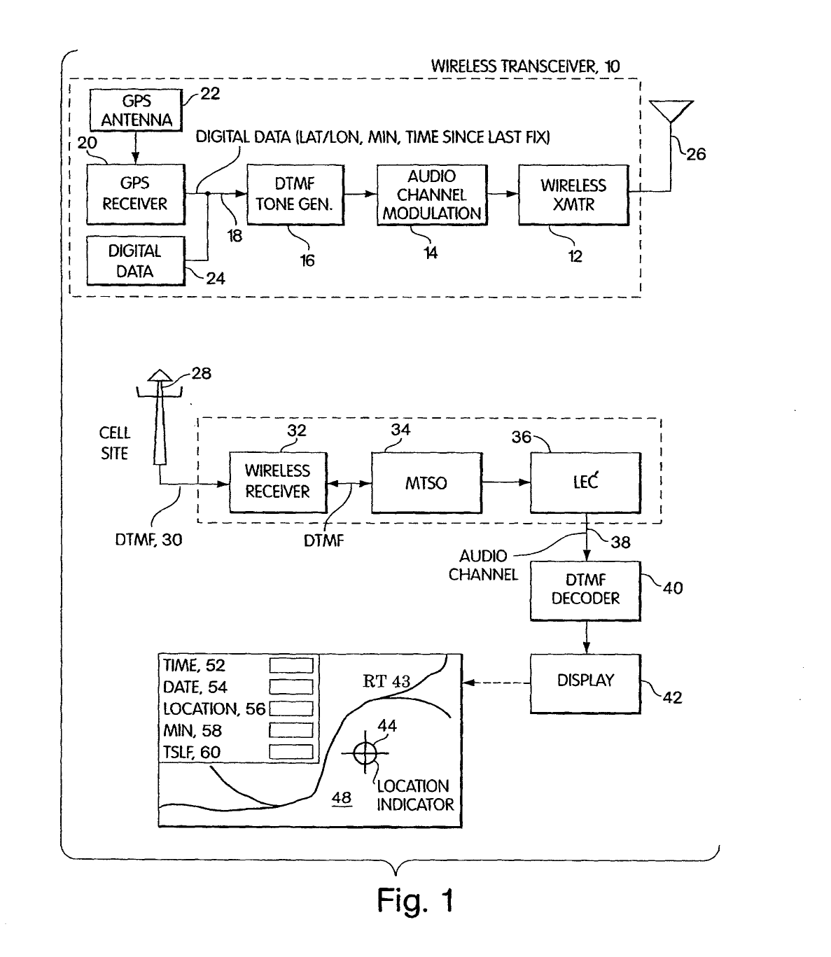

Referring now to FIG. 1, one a wireless transceiver 10 includes a wireless transmitter 12 modulated by an audio channel modulation unit 14 which, in the subject invention, is driven by a DTMF tone generator 16. Tone generator 16 in one embodiment is supplied with the output 18 of a GPS receiver 22, which is coupled to GPS antenna 22.

In the illustrated embodiment, the output signal from the GPS receiver is an NMEA 0183 output, which is converted to DTMF tones corresponding to the latitude and longitude sensed by the GPS receiver. In addition, digital data 24 may be encoded by DTMF tone generator 16 to include the mobile identification number or MIN of the wireless transceiver, the time since last fix which relates to the time since the last receipt of GPS signals, and can include for instance any kind of digital data such as for instance license plate number, or any one of a number of alpha numeric messages.

It is the purpose of the subject invention that this digital information, however garnered, is transmitted via a wireless transceiver antenna 26 to a cell site to 28. The DTMF information, here illustrated at 30, is coupled to a wireless receiver 32, then coupled to an MTSO, 34 a local exchange carrier or LEC 36 and via an audio channel 38 to a DTMF decoder 40.

The output of the DTMF decoder, at least in one embodiment is the transmitted latitude and longitude, which is coupled to a display 42, the output of which is a cursor 44 indicating the location on a map 48 of the wireless transceiver. Additionally the display may display the time 52, the date 54, and an alphanumeric rendition of the location 56, mobile identification number 58 and times since last fix 60.

It will be appreciated that what has transpired is the transmission in a robust fashion of the latitude and longitude of the wireless transceiver to a remote location, in the illustrated example to assist in emergency rescue.

While the subject system has been described so far in connection with emergency signaling, it will be appreciated that robust transmission of digital data, whatever the source, is important in wireless communication systems.

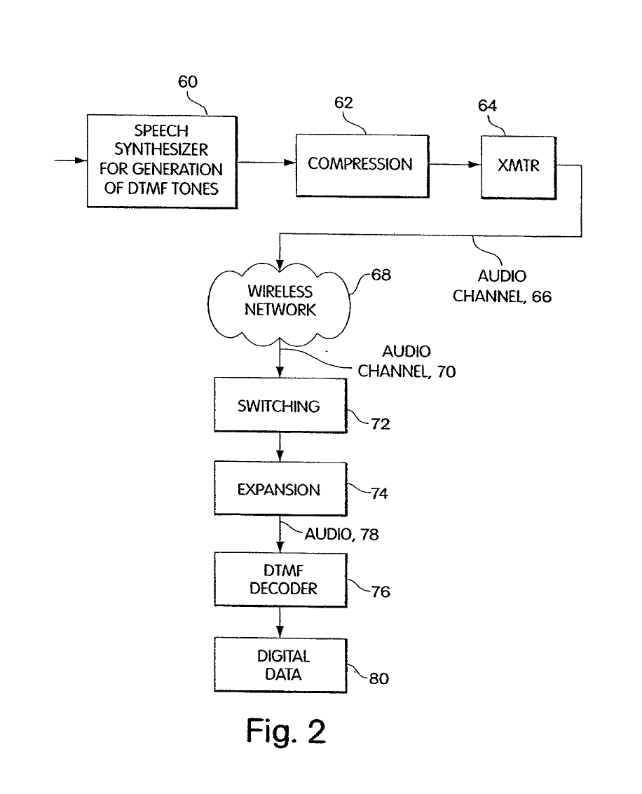

Referring now to FIG. 2, it will be appreciated that in one embodiment a speech synthesizer 60 is utilized for the generation of DTMF tones. Such speech synthesizer may be for instance that available by OKI Semiconductor as the model the P66 series which generates speech and therefore DTMF tones through the utilization of phonemes and does so in an extremely robust manner. The speech synthesizer is preprogrammed with the phonemes, which are then strung together to provide for the speech.

In like manner, DTMF tones can be generated in pure form and encoded into the speech synthesizer by what is known as the PCM method.

The synthesizer can also be of the form of an A-D converter and a D-A converter, which is commonplace but which also faithfully, reproduces the inputted DTMF tones.

As a further alternative, digital signal processing chips may be utilized to generate the tones directly as well as any speech that is required.

Regardless of how the tones are generated, the output of these tones is injected directly into the modulation section of the wireless transmitter where, as illustrated at 62 the digitization of the audio results in compression due to the inherent sampling involved. The output of the digitally transformed audio is provided to the modulation section of transmitter 64 and goes over the audio channel 66 through the wireless network 68 where it is transmitted via an audio channel 70 through switching 72 and expansion 74 to a DTMF decoder 76.

It will be appreciated that the expansion relates to the demodulation of the digitized audio, with the audio 78 being applied to DTMF decoder 76.

The output of the DTMF decoder is the aforementioned digital data 80, which due to the purity of the synthetic speech is very robustly received. The transmission of DTMF tones does not require separate oscillators at the handset, which is the way in which DTMF tones were generated priorly. Rather speech synthesis methods are used for the generation of the DTMF tones in a synthetic speech environment.

What has therefore been provided is a system, which robustly communicates digital data over the audio channel of a digital wireless transceiver in which the data is converted to DTMF tones and the DTMF tones are then digitized by the modulator section prior to transmission. The robustness, aside from being inherent in the DTMF signaling process, also derives from the fact that which is generating the DTMF tones in a preferred embodiment is a speech synthesizer, the output of which is relatively immune to channel degradation and the degradation associated with digitizing audio in general.

Having now described a few embodiments of the invention, and some modifications and variations thereto, it should be apparent to those skilled in the art that the foregoing is merely illustrative and not limiting, having been presented by the way of example only. Numerous modifications and other embodiments are within the scope of one of ordinary skill in the art and are contemplated as falling within the scope of the invention as limited only by the appended claims and equivalents thereto.

What is claimed is:

1. In a digital wireless communication system in which audio information is digitized and transmitted over a communications channel to a remote location, a method for robustly transmitting digital information over the digital wireless communications system, comprising the steps of:
converting the digital information into a stream of audio tones using a speech synthesizer;
transmitting the stream of audio tones over the communication channel to the remote location; and,
detecting and decoding the transmitted stream of audio tones at the remote location to recover the digital information, whereby the use of the speech synthesizer to create the audio tones increases the robustness of the transmission.

2. The method of claim 1, wherein the communications channel includes a voice channel.

3. The method of claim 1, wherein the stream of audio tones are dual tone multiple frequency tones.

4. The method of claim 3, wherein the dual tone multiple frequency tones are in the audible region of the electromagnetic spectrum.

5. The method of claim 1, wherein the digital information includes location information.

6. The method of claim 6, and further including the step of transmitting the digital information in an emergency situation where robustness of transmission of the position information is paramount.

7. The method of claim 1, wherein the wireless communications system includes a wireless transceiver having an audio modulation section and wherein the stream of audio tones is coupled to the audio modulation section.

8. The method of claim 7, wherein the digital information includes the mobile identification number of the wireless transceiver.

9. The method of claim 7, wherein the wireless transceiver includes a CPS receiver having a digital output corresponding to the position of the GPS receiver, and wherein the digital information includes the position of the GPS receiver, whereby location of the wireless transceiver can be robustly reported.

10. The method of claim 1, wherein the speech synthesizer utilizes prerecorded phonemes to generate the audio output thereof.

11. The method of claim 1, wherein the speech synthesizer utilizes A/D and D/A techniques to generate the audio output thereof.

12. The method of claim 1, wherein the speech synthesizer utilizes digital signal processing to generate this audio output thereof.

13. The method of claim 1, wherein the speech synthesizer includes audio oscillators to generate the audio output thereof.

14. A system for robustly transmitting digital data over a digital wireless network in which a communication channel is used to transmit voice communications, comprising:
a wireless transceiver having an audio modulation section in which an audio input is converted into a digital signal transmitted over said communications channel from said transceiver to a remote location;
a speech synthesizer having an audio output coupled to said modulation section; and,
a digital information source coupled to said speech synthesizer for causing said speech synthesizer to output a stream of audio tones corresponding to said digital information; and,
a detector at said remote location for decoding said transmitted audio tones, whereby the generation of said audio tones by a speech synthesizer increases the robustness of the transmission.

15. The system of claim 14, wherein said audio tones are decal tone multiple frequency tones.

16. The system of claim 15, wherein said dual tone multiple frequency tones are in the audible region of the electromagnetic spectrum.
